(19) United States
(12) Patent Application Publication
(10) Pub. No.: US 2009/0259732 A1
(43) Pub. Date: Oct. 15, 2009

(54) VIDEO UPLOAD SYSTEMS AND METHODS

(75) Inventors: Chun Kai Chan, Taipei City (TW); Li-Hsiang Liao, Taipei City (TW); Ya Shu Juang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei City (TW)

(21) Appl. No.: 12/402,615

(22) Filed: Mar. 12, 2009

(30) Foreign Application Priority Data
Apr. 15, 2008 (TW) 97113583

(51) Int. Cl. G06F 15/16

(52) U.S. Cl. 709/219

(57) ABSTRACT

Video upload systems and methods are provided. The system comprises a video capture unit and a management module. The video capture unit captures a video. The management module stores registration data. The management module automatically links to a website according to the registration data, and uploads the video to the website.

### CROSS REFERENCE TO RELATED APPLICATIONS

This Application claims priority of Taiwan Patent Application No. 97113583, filed on Apr. 15, 2008, the entirety of which is incorporated by reference herein.

### BACKGROUND OF THE INVENTION

1. Field of the Invention

The disclosure relates generally to video upload systems and methods, and, more particularly to systems and methods that can automatically upload videos to a website.

2. Description of the Related Art

With the popularization of computers and networks, applications with practical and various functions have been developed. For example, a computer system may be equipped with a TV card, such that users can watch TV and/or videos via the computer system. Additionally, with increase of video websites, users can upload videos on local computer systems to specific websites, such that users can view the videos on the websites via a network, or share the videos to other users.

Currently, users can manually operate the program of the TV card to record videos. After the videos have been recorded, users can manually upload the videos to the specific websites. With the upload procedure requiring related settings, such as IP addresses of the websites and identification data for authentication from users, it is time consuming and complicated for users, indirectly reducing the desire and pleasure of video upload by users.

### BRIEF SUMMARY OF THE INVENTION

Video upload systems and methods are provided.

An embodiment of a video upload system comprises a video capture unit and a management module. The video capture unit captures a video. The management module stores registration data. The management module automatically links to a website according to the registration data, and uploads the video to the website.

In an embodiment of a video upload method, a video is captured. Then, a website is automatically linked according to registration data, and the video is uploaded to the website.

Video upload systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a video upload system of the invention; and

FIG. 2 is a flowchart of an embodiment of a video upload method of the invention.

### DETAILED DESCRIPTION OF THE INVENTION

Video upload systems and methods are provided.

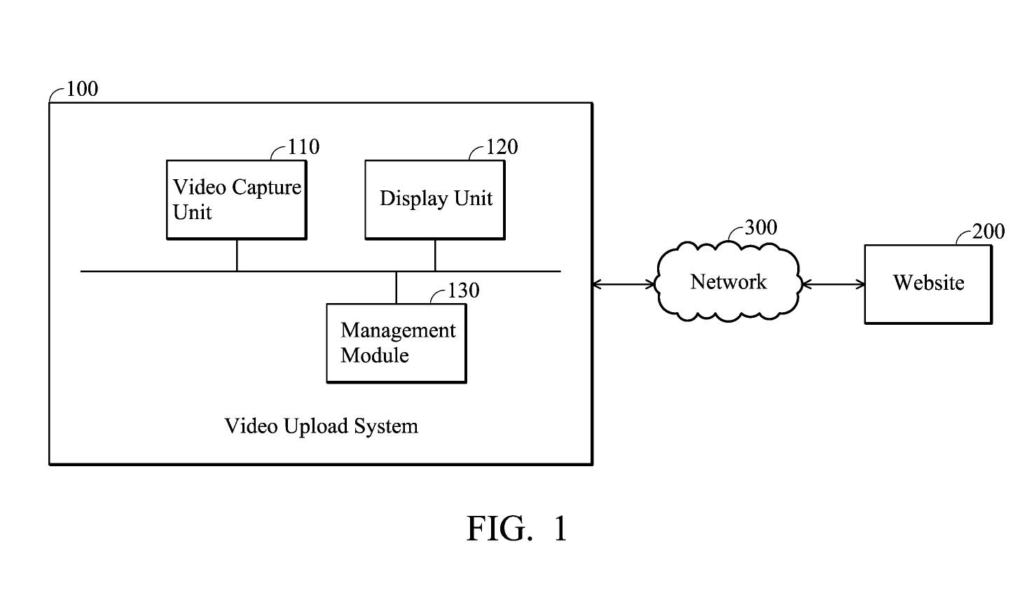

FIG. 1 is a schematic diagram illustrating an embodiment of a video upload system of the invention.

The video upload system is suitable for use in an electronic device. As shown in FIG. 1, the video upload system 100 comprises a video capture unit 110, a display unit 120, and a management unit 130. The video capture unit 110 can be a TV card to receive and/or capture at least one video. The display unit 120 can display the video received by the video capture unit 110, and related user interface (not shown) and data. The management unit 130 performs the video upload method of the invention. The management unit 130 links to a website 200 via a network, such as the Internet 300, and uploads the video to the website 200. The management unit 130 may comprise registration data, such as an IP address of a specific website, an account number and a password corresponding to the specific website, and/or related settings, such as specific times for scheduled recording. In some embodiments, users can finish the data input and settings via the user interface. The management unit 130 is described in more detail later. It is understood that, in the application, the management unit 130 can be implemented using software or hardware. In some embodiments, the management unit 130 may be a driver, such as a TV card program of the video capture unit 110. In some embodiments, the video captured by the video capture unit 110 can be stored in the management unit 130 or a storage unit (not shown).

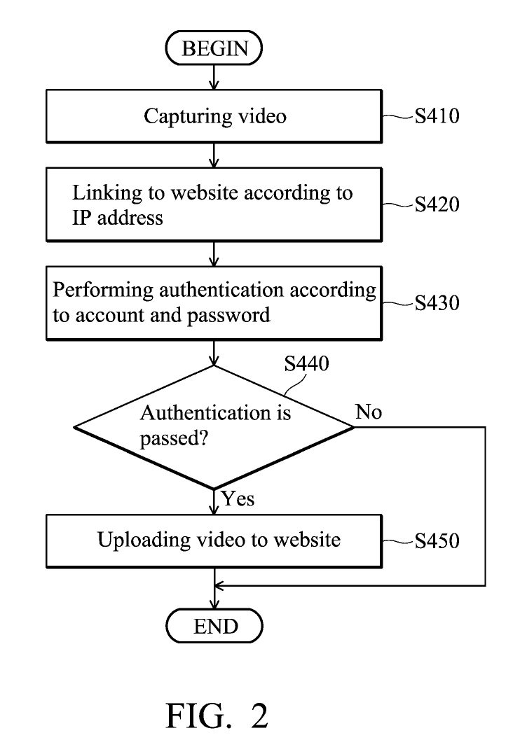

FIG. 2 is a flowchart of an embodiment of a video upload method of the invention.

In step S410, at least one video is captured using the video capture unit 110, such as a TV card. It is understood that, as described, the management unit 130 can record at least one specific time for scheduled recording. The management unit 130 can activate the video capture unit 110 to capture the video at the specific time. It is noted that, the specific time can be set in advance via the user interface, and be stored in the management unit 130. In step S420, a website is linked via a network according to the IP address recorded in the management unit 130. In step S430, the registration data, such as the account number and the password in the management unit 130 is transmitted to the website. The website performs an authentication according to the account number and the password. It is understood that, in some embodiments, users must register the account number and the password on the website in advance, such that the website can accordingly perform the authentication procedure. In step S440, it is determined whether the authentication procedure has passed or not. If the authentication procedure has not passed (No in step S440), the procedure is completed. If the authentication procedure has passed (Yes in step S440), in step S450, the video is uploaded to the website. It is understood that, in some embodiments, after the video is captured by the video capture unit 110, the website can be immediately linked to upload the video.

Therefore, the systems and methods of the application can automatically upload videos to a website. Users can link to the website to view the videos from any location.

Video upload systems and methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A video upload system, comprising:
a video capture unit capturing a video; and
a management module storing registration data, automatically linking to a website according to the registration data, and uploading the video to the website.

2. The system of claim 1, wherein when the management unit links to the website, the management unit transmits the registration data to the website for an authentication, and if the authentication is passed, the management unit uploads the video to the website.

3. The system of claim 2, wherein the registration data comprises an account number and a password.

4. The system of claim 1, wherein the registration data comprises an IP address of the website, and the management unit links to the website according to the IP address.

5. The system of claim 1, wherein the management unit further records a specific scheduled time, and the management unit activates the video capture unit to capture the video at the specific scheduled time.

6. The system of claim 1, wherein the management unit immediately uploads the video to the website after the video is captured by the video capture unit.

7. The system of claim 1, wherein the video capture unit comprises a TV card.

8. A video upload method for a video upload system, the video upload system having a registration data, comprising:
capturing a video;
automatically linking to a website according to the registration data; and
uploading the video to the website.

9. The method of claim 8, wherein when the website is linked, the registration data is transmitted to the website for an authentication, and if the authentication is passed, the video is uploaded to the website.

10. The method of claim 9, wherein the registration data comprises an account number and a password.

11. The method of claim 8, wherein the registration data comprises an IP address of the website, and the website is linked according to the IP address.

12. The method of claim 8, wherein the capturing of the video is activated at a specific scheduled time.

13. The method of claim 8, wherein the video is immediately uploaded to the website after the video is captured.
